(19) United States
(12) Patent Application Publication
(10) Pub. No.: US 2015/0201015 A1
(43) Pub. Date: Jul. 16, 2015

(54) STORAGE SYSTEM AND OPERATION METHOD THEREOF

(71) Applicant: BIGTERA LIMITED, Kowloon (HK)

(72) Inventors: Yung-Hua CHU, Taipei City (TW); Tsung-Lin YU, Taipei City (TW)

(73) Assignee: BIGTERA LIMITED, Kowloon (HK)

(21) Appl. No.: 14/153,621

(22) Filed: Jan. 13, 2014

(51) Int. Cl. H04L 29/08; G06F 3/06

(52) U.S. Cl. CPC H04L 67/1097; G06F 3/0604; G06F 3/0635; G06F 3/067

(57) ABSTRACT

A storage system and an operation method thereof are provided. The storage system comprises at least one independent storage device and at least one independent gateway device. The at least one independent storage device and the at least one independent gateway device are separated. The at least one independent storage device is configured to read in or read out data of at least one electronic device. The at least one independent gateway device is configured to control the access of the data between the at least one electronic device and the at least one independent storage device. The operation method is applied to the storage system to implement the aforesaid operations.

### CROSS-REFERENCES TO RELATED APPLICATIONS

Not applicable.

### BACKGROUND OF THE INVENTION

1. Field of the Invention

The present invention relates to a storage system and an operation method thereof. More particularly, the present invention relates to a network attached storage system and an operation method thereof.

2. Descriptions of the Related Art

The network attached storage (NAS) system is a storage system which has been extensively used in companies. Since the NAS can support many standard network file systems, it can be readily used to store and share data for its clients. Because a client's need for storage may alter over time, a conventional storage structure, known as a scale-out NAS structure, has been provided over recent years. In the scale-out NAS structure, the storage spaces of a plurality of storage nodes are combined via cluster techniques. The storage nodes can be dynamically increased and reduced.

Under conventional scale-out NAS structures, each storage node is a storage device combined with a gateway device. The storage device is configured to provide a storage space for storing data, while the gateway device is configured to control the access of the data. If a storage node is increased or reduced in conventional scale-out NAS structures, its storage space for storing data and access to the data will be increased or reduced simultaneously.

However, the size of storage space and ability of accessing data can be unrelated needs for some clients. For example, clients may merely want to increase or reduce the size of storage space, or they may want to increase or reduce ability of accessing data. Therefore, conventional scale-out NAS storage structures are not appropriate when either the size of storage space or ability of accessing data need to be increased or reduced.

In view of this, it is important make storage space size and data access independent of each other in conventional scale-out NAS structures.

### SUMMARY OF THE INVENTION

An objective of the present invention is to make storage space size and data access independent of each other in conventional scale-out NAS storage structures.

To achieve the aforesaid objective, the present invention provides a storage system. The storage system comprises at least one independent storage device and at least one independent gateway device. The at least one independent storage device and the at least one independent gateway device are separated. The at least one independent storage device is configured to read in or read out data of at least one electronic device. The at least one independent gateway device is configured to control the access of the data between the at least one electronic device and the at least one independent storage device.

To achieve the aforesaid objective, the present invention further provides an operation method for a storage system. The storage system comprises at least one independent storage device and at least one independent gateway device. The at least one independent storage device and the at least one independent gateway device are separated. The operation method comprises the following steps:

(a1) reading in or reading out data of the at least one electronic device by the at least one independent storage device; and

(b1) controlling the access of the data between the at least one electronic device and the at least one independent storage device by he at least one independent gateway device.

In summary, the present invention provides a storage system and an operation method thereof. With the aforesaid arrangements of the at least one independent storage device and the at least one independent gateway device, the storage system and the operation method thereof separate the size of storage spaces and ability of accessing data. Consequently, the present invention makes the storage space size and data access independent of each other in conventional scale-out NAS storage structures.

The detailed technology and preferred embodiments implemented for the present invention are described in the following paragraphs accompanying the appended drawings for persons skilled in the art to well appreciate features of the claimed invention.

### BRIEF DESCRIPTION OF THE DRAWINGS

FIG. 1 is a schematic view of a storage system according to a first embodiment of the present invention; and

FIG. 2 is a diagram of an operation method for a storage system according to a second embodiment of the present invention.

### DESCRIPTION OF THE PREFERRED EMBODIMENT

The present invention may be explained with reference to the following embodiments. However, these embodiments are not intended to limit the present invention to any specific environments, applications or implementations described in these embodiments. Therefore, the description of these embodiments is only for the purpose of illustration rather than to limit the present invention. In the following embodiments and the attached drawings, elements not directly related to the present invention are omitted from depiction. In addition, the dimensional relationships among individual elements in the attached drawings are illustrated only for ease of understanding, but not to limit the actual scale.

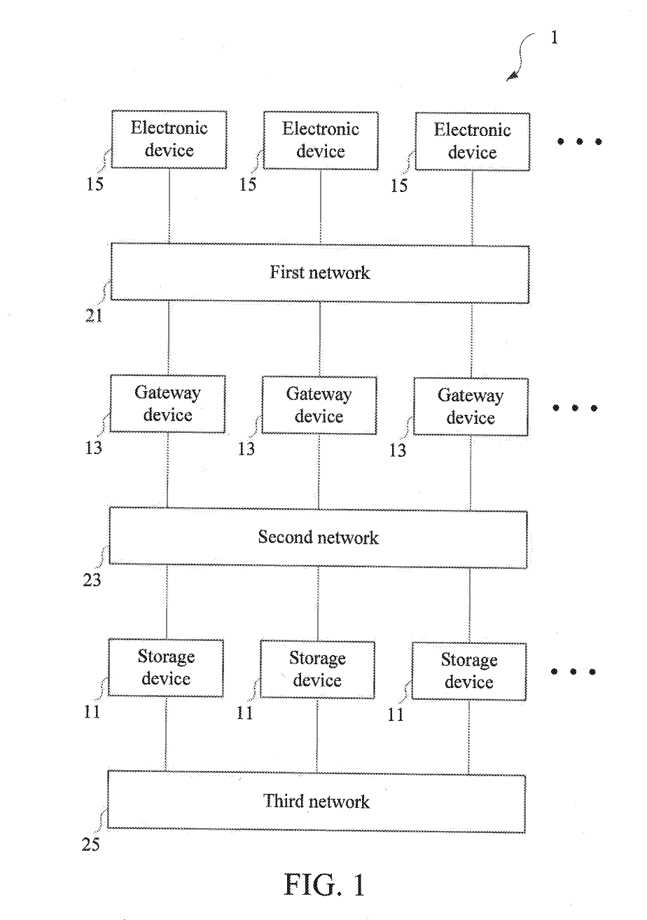

A first embodiment of the present invention is a storage system. A schematic structural view of the storage system is shown in FIG. 1 where the storage system 1 comprises at least independent storage device 11 and at least one independent gateway device 13. The at least one independent storage device 11 described in this embodiment may be one single independent storage device or a plurality of independent storage devices. Multiple independent storage devices 11 may be grouped as a storage cluster. The at least one independent gateway device 13 described in this embodiment ay be one single independent gateway device or a plurality of independent gateway devices. Multiple independent gateway devices 13 may be grouped as a gateway cluster.

The storage system 1 may be a NAS system; however, unlike conventional NAS systems, the at least one independent storage device 11 and the at least one independent gateway device 13 are separated as different independent nodes. The storage system 1 may also be applied to other storage systems wherein one single storage node has to include one storage device and one gateway device simultaneously.

The at least one independent storage device 11 is configured to read in or read out data of at least one electronic device 15. In other words, the data of the at least one electronic device 15 can be stored into the at least one independent storage device 11 and read out from the at least one independent storage device 11. The at least one electronic device 15 described in this embodiment may be one single electronic device or a plurality of electronic devices. Each electronic device 15 may be an electronic device of any kind, such as a personal computer, a laptop, a tablet computer, a cellular phone, a PDA, etc. Substantially, each independents age device 11 in terms of functionality can play the role of the storage device integrated into one single storage node of the conventional NAS system.

The at least one independent gateway device 13 is configured to control access of the data between the at least one electronic device 15 and the at least one independent storage device 11. The access of the data, for example, may involve the throughput, the authorization, the transmission rate, etc., between the at least one electronic device 15 and the at least one independent storage device 11. Substantially, each independent gateway device 13 in terms of functionality can play the role of the gateway device integrated into one single storage node of the conventional NAS system.

As shown in FIG. 1, the at least one independent gateway device 13 may be connected with the at least one electronic device 15 via a first network 21 and connected with the at least one independent storage device 11 via a second network 23. The first network 21 may include a first switching device (not shown) to connect the at least one independent gateway device 13 with the at least one electronic device 15 so that the at least one independent gateway device 13 can communicate with the at least one electronic device 5 in the first network 21. Likewise, the second network 23 may include a second switching device (not shown) to connect the at least one independent gateway device 13 with the at least one storage device 11 so that the at least one independent gateway device 13 can communicate with the at least one storage device 11 in the second network 23.

Furthermore, as a plurality of independent storage devices 11 are considered, the plurality of independent storage devices 11 may communicate in a third network 25. Specifically, the third network. 25 may include a third switching device (not shown) to connect the plurality of independent storage devices 11 so that the plurality of independent storage devices 11 can communicate to each other in a third network 25.

The first network 21, the second network 23 and the third network 25 may be different and independent from each other. Alternatively, at least two of the first network 21, the second network 23 and the third network 25 are the same. That is, all or two of the first network 21, the second network 23 and the third network 25 may be the same. Thus, in response to different applications, the implementation of the first network 21, the second network 23 and the third network 25 can be adaptively created with the same type or different types. Furthermore, each of the implements of the first network 21, the second network 23 and the third network 25 can be individually and particularly designed to enhance its specific network ability.

Under the structure of the storage system 1, the at least one independent storage device 11 and the at least one independent gateway device 13 are divided into two different and separate clusters. In other words, the number of independent storage devices 11 and independent gateway devices 13 can be increased or reduced separately.

Since the at least one independent storage device 11 is unrelated to the at least one independent gateway device 13 in functionality, each of them can be optimized in hardware or software for its individual needs. For example, the at least one independent storage device 11 may by optimized for the network transmission rate, while the at least one independent gateway device 13 may by optimized for storage capacity. Therefore, the storage system 1 reaches a need of high availability and has the ability to dynamically share resources and expand capacity.

A second embodiment of the present invention is an operation method for a storage system. The operation method described in this embodiment may be applied to the storage system 1 described in the first embodiment. Therefore, the storage system described in this embodiment may be considered as the storage system 1 described in the first embodiment. The storage is n described in this embodiment may comprise at least one independent storage device and at least one independent gateway device. Furthermore, the at least one independent storage device and the at least one independent gateway device are separated.

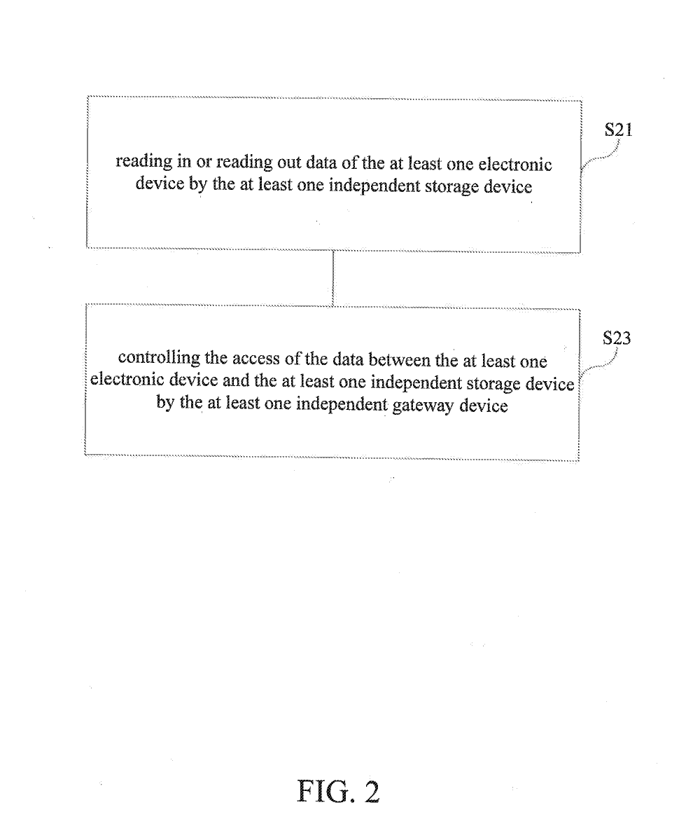

A diagram of the operation method is shown in FIG. 2. As shown in FIG. 2, step S21 is executed to read in or read out data of the at least one electronic device by the at least one independent storage device; and step S23 is executed to control the access of the data between the at least one electronic device and the at least one independent storage device by the at least one independent gateway device.

In an example of this embodiment, the storage system may be a network attached storage system. In an example of this embodiment, the at least one independent gateway device may be connected with the at least one electronic device via a first network and connected with the at least one independent storage device via a second network. In an example of this embodiment, the at least one independent storage device may comprise a plurality of independent storage devices. The independent storage devices communicate in a third network. The first network, the second network and the third network may be independent. Alternatively, at least two of the first network, the second network and the third network may be the same.

In addition to the aforesaid steps, the operation method of this embodiment further comprises other steps corresponding to all the operations of the storage system 1 set forth in the first embodiment and accomplishes all the corresponding functions. Since the steps which are not described in this embodiment can be readily appreciated by persons skilled in the art based on the explanations of the first embodiment, they will not be further described herein.

According to the above descriptions, the present invention provides a storage system and an operation method thereof. With the aforesaid arrangements of the at least one independent storage device and the at least one independent gateway device, the storage system and the operation method thereof provide a method for storage space size and data access to be handled separately. Consequently, the present invention can effectively make the storage space size and data access independent of each other in conventional scale-out NAS structures.

The above disclosure is related to the detailed technical contents and inventive features thereof. Persons skilled in the art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A storage system, comprising:
at least one independent storage device, configured to read in or read out data of at least one electronic device; and
at least one independent gateway device, configured to control the access of the data between the at least one electronic device and the at least one independent storage device;
wherein the at least one independent storage device and the at least one independent gateway device are separated.

2. The storage system as claimed in claim 1, wherein the storage system is a network attached storage (NAS) system.

3. The storage system as claimed in claim 1, wherein the at least one independent gateway device is connected with the at least one electronic device via a first network and connected with the at least one independent storage device via a second network.

4. The storage system as claimed in claim 3, wherein the at least one independent storage device comprises a plurality of independent storage devices and the independent storage devices communicate in a third network.

5. The storage system as claimed in claim 4, wherein the first network, the second network and the third network are independent.

6. The storage system as claimed in claim 4, wherein at least two of the first network, the second network and the third network are the same.

7. An operation method for a storage system, the storage system comprising at least one independent storage device and at least one independent gateway device, the at least one independent storage device and the at least one independent gateway device being separated, the operation method comprising the following steps:
(a1) reading in or reading out data of the at least one electronic device by the at least one independent storage device; and
(b1) controlling the access of the data between the at least one electronic device and the at least one independent storage device by the at least one independent gateway device.

8. The operation method as claimed in claim 7, wherein the storage system is a network attached storage system.

9. The operation method as claimed in claim 7, wherein the at least one independent gateway device is connected with the at least one electronic device via a first network and connected with the at least one independent storage device via a second network.

10. The operation method as claimed in claim 9, wherein the at least one independent storage device comprises a plurality of independent storage devices and the independent storage devices communicate in a third network.

11. The operation method as claimed in claim 10, wherein the first network, the second network and the third network are independent.

12. The operation method as claimed in claim 10, wherein at least two of the first network, the second network and the third network are the same.
